(19) United States
(12) Patent Application Publication
(10) Pub. No.: US 2026/0360007 A1
(43) Pub. Date: Nov. 12, 2026

(54) BACK PROJECTION USING LASER TRACKING

(71) Applicant: Virtek Vision International Inc., Waterloo (CA)

(72) Inventor: Ahmed ELHOSSINI, Waterloo (CA)

(21) Appl. No.: 19/671,756

(22) Filed: May 8, 2026

Related U.S. Application Data
(60) Provisional application No. 63/801,939, filed on May 8, 2025.

(51) Int. Cl. G06T 7/73; G01N 21/88; G06T 7/00

(52) U.S. Cl. CPC G06T 7/73; G01N 21/8806; G06T 7/0006; G06T 7/001; G01N 2201/06113; G06T 2207/20084

(57) ABSTRACT

A method of identifying a defect on an inspection surface is disclosed. An inspection surface is located within a coordinate system. An image of an inspection surface is generated for identifying a location of a defect on the inspection surface. A laser icon is projected onto the inspection surface to an initial location and a location of the laser icon is determined within the coordinate system. A difference in location between the defect and the laser icon is calculated. Additional laser icons are iteratively projected onto the inspection surface at locations that are increasingly closer to the defect until a threshold distance between the defect and the icon is determined. Once the threshold distance has been identified, laser indicia is projected toward the defect for providing a visible indication of the location of the defect on the inspection surface.

### PRIOR APPLICATION

The present application claims priority to United States Provisional Patent Application No. 63/801,939 filed on May 8, 2025, the contents of which are included herein in entirety.

### TECHNICAL FIELD

The present application relates generally toward identification of defects on an inspection surface. More specifically, the present application leads toward inspecting and generating icons to identify the location of a defect on an inspection surface.

### BACKGROUND

Machine inspection of work surfaces is becoming more critical to improve quality of manufactured articles while still maintaining manufacturing efficiency. To replace manual inspection, various electronic devices have been implemented with an effort to improve the identification of defects on manufactured articles. Cameras and other types of sensors have been implemented to identify defects on a work surface or manufactured article to some degree of success. While sensor technology is improving to the extent that repeatable accuracy in identifying defects is now achievable, indicating location of these defects has not yet been sufficiently achieved in a manner that provides desired speed and accuracy in production environments. Merely generating an image of a defect and signaling that image to the processor or video screen that is remote from the work area is not particularly useful.

Therefore, a need exists to provide a rapid identification of a defect upon a work or inspection surface within a work area that efficiently enables an operator to take corrective action.

### SUMMARY

A method of identifying a defect on an inspection surface is disclosed. An inspection surface is located within a coordinate system. An image of an inspection surface is generated for identifying a location of a defect on the inspection surface. A laser icon is projected onto the inspection surface to an initial location and a location of the laser icon is determined within the coordinate system. A difference in location between the defect and the laser icon is calculated. Additional laser icons are iteratively projected onto the inspection surface at locations that are increasingly closer to the defect until a threshold distance between the defect and the icon is determined. Once the threshold distance has been identified, laser indicia is projected toward the defect for providing a visible indication of the location of the defect on the inspection surface.

One problem with using laser projection to project laser icon onto or around the defect is calibrating or registering the laser projector to the work surface and to the camera that generate the images of the work surface. When registering a work surface, a common coordinate system is generated providing a location within the coordinate system of each of the work surface, laser projector, and photogrammetry system. This is often difficult and requires precise three dimensional location of these articles to be determined within the common three-dimensional coordinate system. The system of the present invention eliminates a need for registering all of these articles within the coordinate system.

As such, the system and method of the present invention eliminates the need to identify a location of any of these articles within the three-dimensional coordinate system. Therefore, it should be understood by one of ordinary skill in the art that the camera and the laser projector need not even be located relative to each other. The camera need only signal an image to the processor for the processor to determine coordinates of the defect relative to the laser indicia as will be explained further hereinbelow. Based upon this initial determination, the processor directs the laser to generate additional laser projections sequentially moving the projected indicia closer to the defect until the distance between the defect and the laser indicia is within a threshold distance at which time the processor signals the laser to project an icon identifying the location of the defect for the operator to view. This process occurs rapidly and only requires an amount of time for the processor to calculate and signal the laser projector to project additional indicia. Thus, there is no discernable delay from the time the camera identifies the defect, and the laser generates an icon signaling the location of the defect to the operator.

### BRIEF DESCRIPTION OF THE DRAWINGS

Other advantages of the present invention will be readily appreciated as the same becomes better understood by reference to the following detailed description, when considered in connection with the accompanying drawing, wherein:

FIG. 1 shows a schematic of the process of the present invention;

FIG. 2 shows a first projection of a first laser indicia onto an inspection surface;

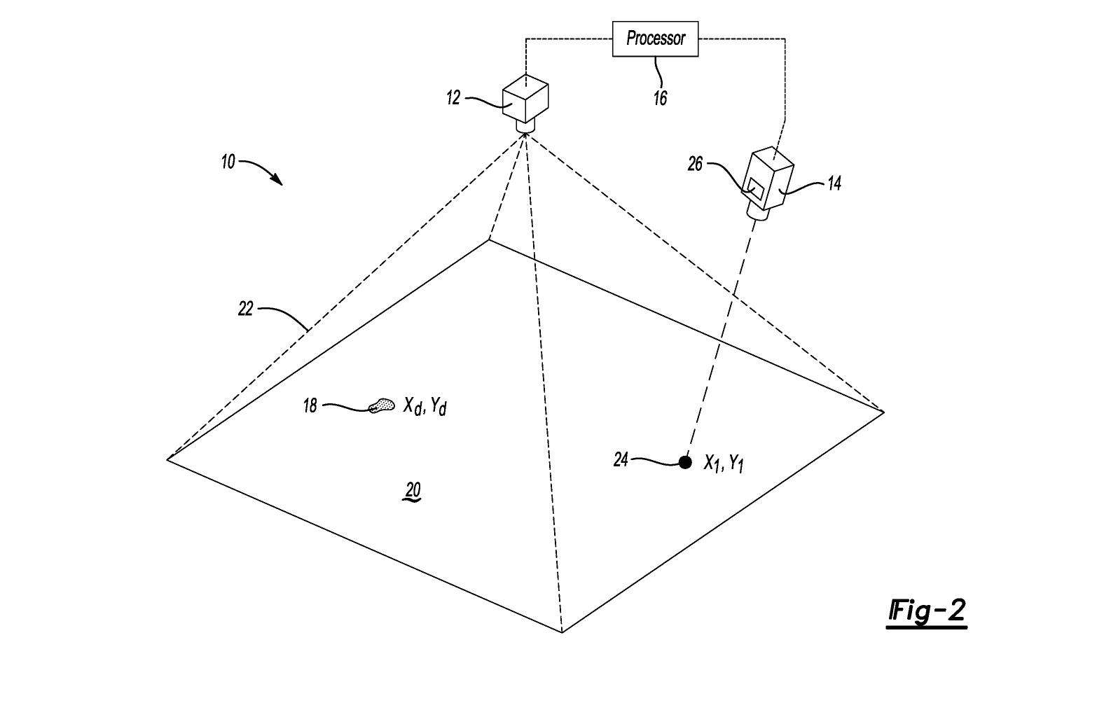

FIG. 3 shows a second projection of a second laser indicia onto the inspection surface;

FIG. 4 shows projection of a laser icon onto the inspection surface identifying a location of a defect; and

FIG. 5 shows flow chart of the process of the present invention.

### DETAILED DESCRIPTION

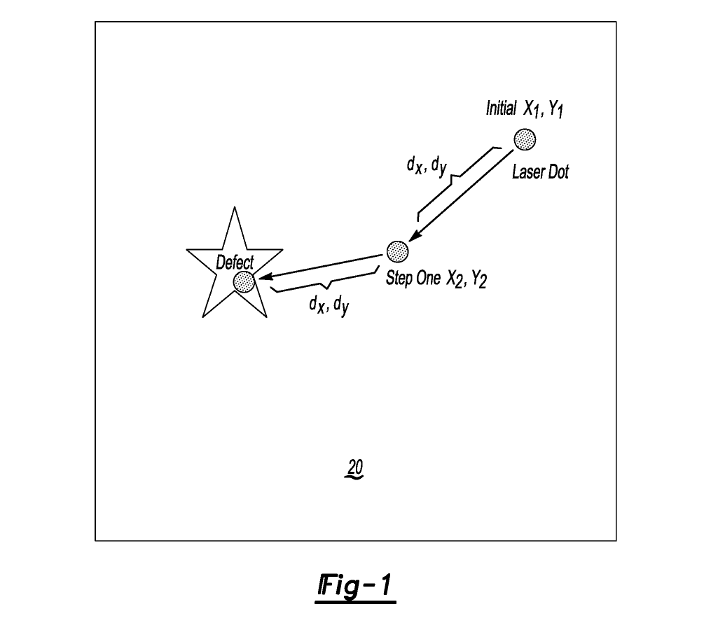

Referring to FIG. 1, an inspection system of the present invention is generally shown at 10. The system 10 includes a camera 12 and a laser projector 14. A processor 16 electronically connects the camera 12 and the laser projector 14. The camera 12 and laser projector 14 are directed by the processor 16 to identify a defect 18 upon an inspection surface 20. The camera 12 and the laser projector 14 need not be interconnected within a common housing, such as, for example the system disclosed in United States Patent No. 9,200,899 LASER PROJECTOR AND SYSTEM, the contents of which are included herein by reference. Further, in one embodiment, the camera 12 and the laser projector 14 need not be registered in a three dimensional coordinate system to identify the location of a defect upon an inspection surface. Alternatively, the camera 12 and laser projector 14 may be included within a common housing located relative to each other as disclosed in United States Patent No. 10,239,178 LASER PROJECTOR WITH DYNAMICALLY ADAPTABLE FOCUS, the contents of which are included herein by reference.

In one embodiment, the defect 18 is identified by analysis using Computer Aided Design (CAD) data. The defect 18 is initially identified as being out of conformance with the CAD data by implementing artificial intelligence algorithms as explained further herein below.

The camera 12 may include either a CCD or CMOS sensor to generate pixel images of the inspection surface 20. Other imaging sensors are within the scope of this invention. The camera 12 establishes a field of view 22 that encompasses the inspection surface 20. In one embodiment, the camera 12 establishes X and Y coordinates on the inspection surface 20 within a two dimensional coordinate system. In another embodiment, the camera establishes X, Y, and Z coordinates within a three-dimensional coordinate system. For brevity, the method of the present application will be explained using two dimensional coordinate systems focusing on X and Y coordinates. However, it should be understood by those of ordinary skill in the art that implementation of a system that inspects a three-dimensional surface is within the scope of this invention.

The camera 12 signals the processor 16 an image of the inspection surface 20 enabling the processor to calculate a location of a defect 18 identified within the image within the two-dimensional coordinate system. The camera is of suitable resolution to identify elements on the inspection surface 20 that are matched with CAD data for generating coordinates for the inspection surface 20. Thus, the processor assigns X_{d},Y_{d} coordinates to the defect within the two-dimensional coordinate system. The defect can be of any type including misalignment of a component affixed to the inspection surface, a defective ply or ply placement attached to the inspection surface, or even a defect in the inspection surface itself.

The laser projector 14 it is directed by the processor 16 to project laser generated first icon 24 onto the inspection surface 20. However, the first icon 24 need not be projected onto the inspection surface 20 but only within the field of view 22 of the camera 12. A precise location of the first icon 24 is not established by alignment of a galvanometer device used to direct location of the first icon 24 on the inspection surface. The first icon 24 may take the form of a laser dot, a laser blob, or any other icon that is detectable by the camera 12. Once detected by the camera 12 an image of the first icon 24 is signaled to the processor 16. The processor 16 assigns first icon coordinates X₁, Y₁to the first icon 24 within the coordinate system established for the work surface 20.

The processor 16 thusly calculates the defect coordinates X_{d},Y_{d} and the first icon coordinates X₁, Y₁ within the common coordinate system defined on the inspection surface. From this preliminary calculation, the processor16 calculates a differential d_{X}, d_{y}, or distance between the defect coordinates X_{d},Y_{d} and the first icon coordinates X₁, Y₁. Once calculated, the processor 16 signals the laser projector to realign the galvanometer device 26 to redirect a second laser projection in a direction closer in proximity to the defect coordinates X_{d},Y_{d}.

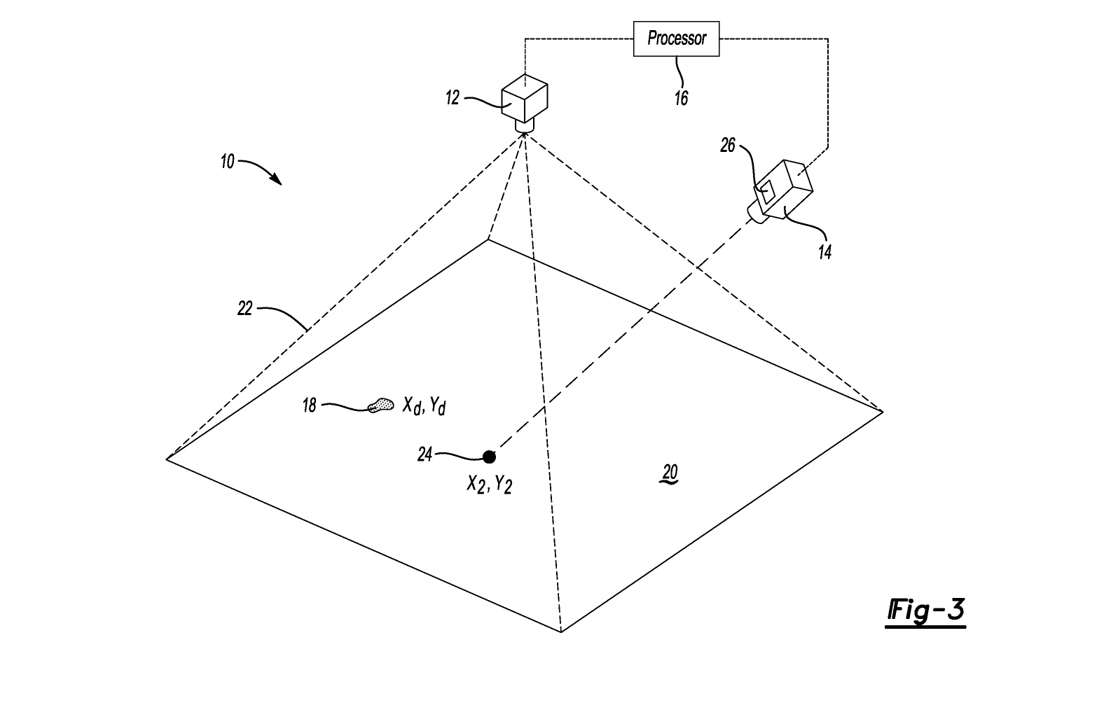

As shown in FIG. 3, the laser projector 14 projects a second icon 28 onto a second location of the inspection surface 20. The camera 12 generates a second image of the inspection surface capturing the second icon 28 with the image sensor. Once captured, the image is signaled to the processor 16 and the processor 16 calculates second icon coordinates X₂, Y₂ within the coordinate system of the inspection surface 20. Once again, the processor 16 calculates a differential between the defect coordinates X_{d},Y_{d} and the second icon coordinates X₂, Y₂. Because the galvanometer device 26 has redirected projection of the second icon 28 toward the defect coordinates X_{d},Y_{d}, the differential d_{X}, d_{Y} between the defect 18 and the second icon 28 now is less than the differential between the defect 18 and the first icon 24.

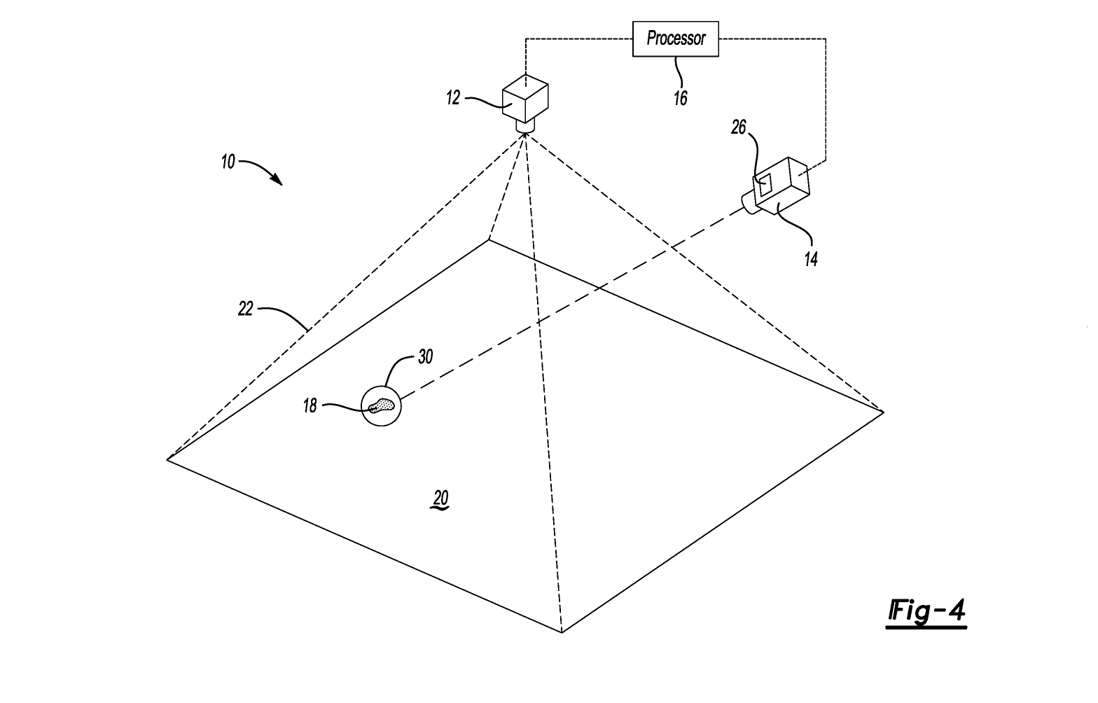

The steps describe hereinabove of projecting the first icon 24 and the second icon 28 are repeated iteratively until the differential d_{X}, d_{Y} is within a predefined threshold distance. Once the processor 16 calculates the differential d_{X}, d_{Y} is within the predefined threshold distance, the laser projector 14, and more particularly the galvanometer device 26 is directed by the processor 16 to project laser indicia 30 in a manner that identifies the location of the defect 18 as is best represented in FIG. 4. In one embodiment, the indicia 30 takes the form of a ring projected onto the inspection surface 20 around the defect 18. Alternatively, the indicia 30 may take the form of an arrow or other shape projected on the inspection surface 20 indicating location of the defect 18.

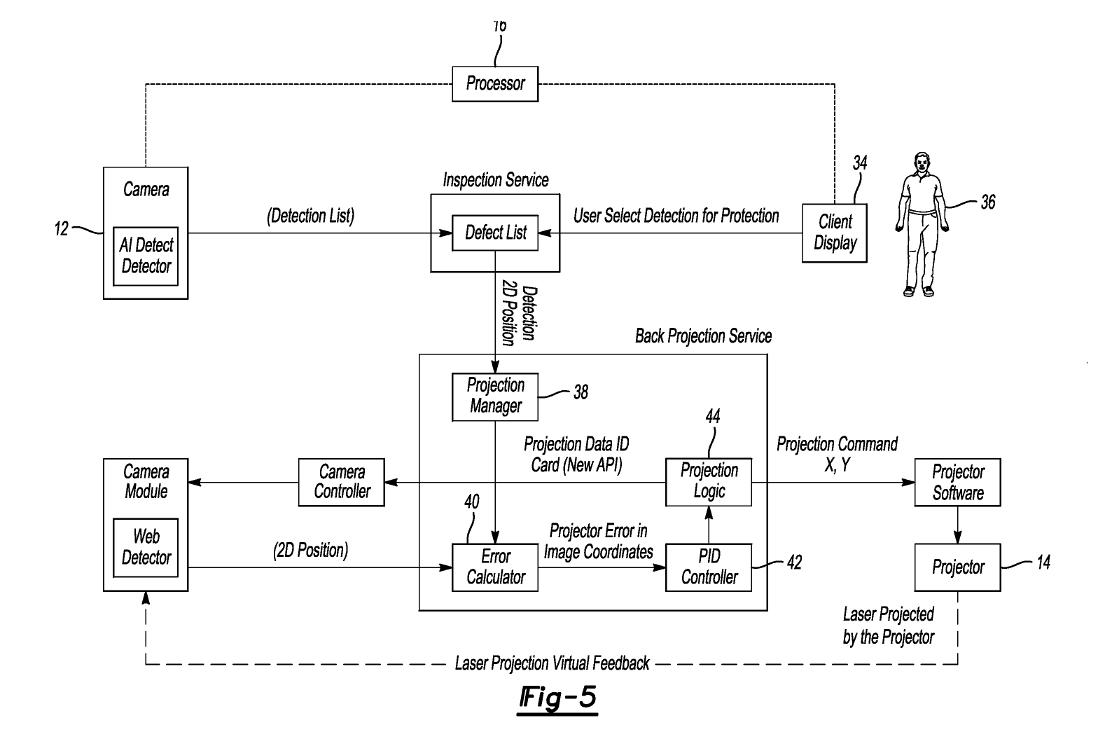

Referring now to FIG. 5, a flow chart representing the system described above will now be explained. In one embodiment, the processor 16 adopts Machine Learning by way of convolutional neural network (CNN) architectures thought to be adequate for industrial inspection to verify if a component has been installed in a correct position, i.e., within specified GD&T tolerance or otherwise identify a defect in the inspection surface 20 as required by the CAD data. While CNN is discussed throughout the application, it should be understood that CNN is merely exemplary and that other types of machine learning models are also within the scope of this application. As is known to those of skill in the art, GD&T represents general dimensioning and tolerance standard associated with quality criteria establishing a dimensional threshold for accurate assembly. Most of the CNN architectures are trained and evaluated to detect normal objects such as people, cars, trees, and animals. Thus, as an initial step, the camera 12 generates an image of the inspection surface 20. Through the CNN architecture, the defect 18 is identified from the image of the inspection surface 20 by the processor 16. The CNN architecture disclosed in co-pending patent application Nos. 18/087,250, METHOD AND SYSTEM FOR INSPECTING A SURFACE WITH ARTIFICIAL INTELLIGENCE ASSIST and 18/133,739, METHOD AND SYSTEM FOR INSPECTING A SURFACE WITH ARTIFICIAL INTELLIGENCE ASSIST disclose various techniques of integrating artificial intelligence with camera based inspection and the contents of each are included herein by reference in entirety.

The defect 18 may be identified at a display 34 that is remote to the work surface, but observable by an operator 36. This is particularly necessary when the inspection surface 20 is a large object, such as, for example, a wind turbine blade or an aerospace wing. Once the defect 18 is identified, the processor assigns a two dimensional coordinate X_{d},Y_{d} to the defect 18 within the coordinates system defined at the inspection surface 20.

Once the two-dimensional coordinate X₁,Y₁ has been assigned, a first icon 24 is projected by the laser projector 14 to a location within the field of view 22 of the camera 12. A projection manager 38 initiates an error calculator 40 to determine a differential between a two-dimensional coordinate X₁,Y₁of the first icon 24 and the two-dimensional coordinate X_{d},Y_{d} of the defect 18. Thus, an X_{d}X₁ and an Y_{d}Y₁ first differential is calculated. In an embodiment that three dimensional determinations are desired, the differential is determined in three dimensions of X_{d}X₁, Y_{d}Y₁, and Z_{d}Z₁.

Once the error calculator 40 has determined the differential between the first icon 24 and the defect coordinates a Proportional Integral Derivative (PID) calculation is initiated by a PID controller 42. The PID controller 42 is a combination of proportional, integral, and derivative calculation to regulate a process variable by adjusting a manipulated variable the function of which will be explained further hereinbelow. However, the disclosure of a PID controller hereinabove is merely exemplary and it should be understood that other variable controllers are also within the scope of this invention.

The processor 16 initiates projection of a second icon 28 by the laser projector 14 via projection logic 44 making use of the PID controller 42 algorithms decreasing the differential to the defect 18 from that of the first icon 24. The camera 12 generates an image of the second icon 28 and signals the image to the processor 16 enabling the processor to calculate second icon coordinates X₂,Y₂of the second icon 28 within the two-dimensional coordinate system. Thus, the processor 16 via the error calculator 40, when functioning in a two dimensional coordinate system calculates the second differential d_{X}, d_{Y}.

The PID controller 42 repeats the sequence explained hereinabove iteratively decreasing the differential X_{d}X_{d}, Y_{d}Y_{d} between subsequent projected icons and the defect 18 until the predetermined threshold differential is reached. Once the threshold differential has been reached, the processor 16 signals the laser projector to scan the laser indicia 30 identifying for an operator 36 who is proximate the inspection surface 20 the location of the defect 18.

The invention has been described in an illustrative manner; many modifications and variations of the present invention are possible. Is therefore to be understood within the specification the reference numerals are merely for convenience and are not to be in any way limiting, and that the invention may be practiced otherwise then is specifically described. Therefore, the invention can be practiced otherwise then is specifically described within the scope of the stated claims following the aforementioned disclosed embodiment.

What is claimed is:

1. A method of identifying a defect on an inspection surface, comprising the steps of:
identifying an inspection surface within a coordinate system;
generating a camera image of the inspection surface for identifying a defect disposed at the inspection surface;
identifying a location of a defect on the inspection surface within the coordinate system from the camera image of the inspection surface;
using a laser projector for projecting a first laser icon onto the inspection surface to an initial location and identifying a location of the first laser icon within the coordinate system;
calculating a difference in distance between the defect and the first laser icon;
iteratively projecting additional laser icons onto the inspection surface at locations being increasingly closer in distance to the defect until a threshold distance between the defect and the icon is identified; and
when said threshold distance has been identified, projecting laser indicia toward the defect for providing a visible indication of the location of the defect on the inspection surface.

2. The method set forth in claim 1, wherein said step of identifying a location of a defect on an inspection surface is further defined by identifying a location within a two dimensional coordinate system.

3. The method set forth in claim 2, wherein said step of identifying a location of the first laser icon within the coordinate system is further defined by identifying the location of the first laser icon with a common two dimensional coordinate system with the defect.

4. The method set forth in claim 1, wherein said step of identifying a location of a defect and identifying the location of the first laser icon is further defined by using an imaging device for identifying the location of the defect and the first laser icon.

5. The method set forth in claim 1, further including a step of initiating a calculation for iteratively directing said laser projector to project additional laser icons onto the inspection surface at locations being increasingly closer in distance to the defect.

6. The method set forth in claim 5, wherein said step of initiating a calculation is further defined by initiating a processor to calculate a differential d_{X} d_{y} or distance between the defect coordinates X_{d}Y_{d} and the first icon coordinates X₁ Y₁.

7. The method set forth in claim 6, wherein said processor is configured to perform a Proportional Integral Derivative (PID) calculation.

8. The method set forth in claim 1, wherein said step of identifying a defect is further defined by analyzing the image of the defect using a convolutional neural network (CNN).

9. The method set forth in claim 1, wherein said step of projecting laser indicia toward the defect for providing a visible indication of the location of the defect on the inspection surface is further defined scanning at least one of a ring or a chevron on said inspection surface proximate to the defect.

10. The method set forth in claim 1, further including a step of identifying a location of the defect on a display being remote from the inspection surface.

11. The method set forth in claim 1, wherein said step of generating an image of an inspection surface is further defined simultaneously generating an image of the laser icon.

12. The method set forth in claim 1, wherein said defect is identified relative to CAD data and GD&T requirements using CNN.
